(19) United States
(12) Patent Application Publication
(10) Pub. No.: US 2026/0037314 A1
(43) Pub. Date: Feb. 5, 2026

(54) FRAME COUNTER RECORDAL AND AN ENERGY LIMITED DEVICE

(71) Applicant: SCHNEIDER ELECTRIC ASIA PTE LTD, Singapore (SG)

(72) Inventors: Caijin WANG, Singapore (SG); Mathew Adam WILLIAMS, Singapore (SG)

(21) Appl. No.: 18/997,491

(22) PCT Filed: Jul. 22, 2022
(86) PCT No.: PCT/SG2022/050520

§ 371 Date: Jan. 21, 2025

(51) Int. Cl. G06F 9/50

(52) U.S. Cl. CPC G06F 9/5027

(57) ABSTRACT

A method of recording a frame counter in a memory component of an energy limited device and an energy limited device are provided, the method comprising, accessing the memory component; wherein for a first recordal, allocating a memory space of the memory component based on a value of a predetermined maximum frame counter number for the energy limited device, with each bit of the allocated memory space being populated with an empty space indicia; and wherein for the first recordal and each subsequent recordal, accessing a first bit position with the empty space indicia based on a predetermined writing instruction and converting the empty space indicia of the first bit position to a frame counter indicia wherein the first bit position with the frame counter indicia indicates a current frame counter number.

### TECHNICAL FIELD

The present disclosure relates broadly to a method of recording a frame counter in a memory component of an energy limited/harvesting device and an energy limited/harvesting device.

### BACKGROUND

For operation of machinery or devices, increasingly, actuators are being used with batteryless transmitters to transmit command signals to receivers at the machinery or devices. Such batteryless transmitters can be wireless transmitters and may be standalone energy harvesting/limited devices.

Typically, when a signal is sent to a receiver, a frame of the signal is encrypted so that the signal is secure and cannot be hacked by a third party. However, even if the frame of the signal is encrypted, the inventors recognise that it is possible for a hacker to compromise a machinery or device at the receiver. A hacker may obtain/copy a previously-transmitted signal containing a command and re-transmit the copied signal to cause problems at the machinery or device. That is, the copied signal containing an unintended command may cause problems at the machinery or device.

For example, when an actuator e.g. a push button of a wireless transmitter device that is an energy harvesting/limited device is activated/pushed, an encrypted frame containing a command/instruction is sent/transmitted to a receiver coupled to a machinery e.g. a gate. When the receiver receives the encrypted frame, the instruction is processed to determine whether to either open or close the gate.

For example, when encrypted frame 1 (with a command to open the gate) is sent/transmitted to a gate control receiver, the gate is opened. When a subsequent encrypted frame 2 (with a command to close the gate) is sent/transmitted to the gate control receiver, the gate is closed. The actuator may be used a number of times thereafter to open or close the gate. For example, a subsequent encrypted frame 3 is sent/transmitted to the gate control receiver to open the gate and a subsequent encrypted frame 4 is sent/transmitted to the gate control receiver to close the gate. Then, a subsequent encrypted frame 5 is sent/transmitted to the gate control receiver to open the gate and a subsequent encrypted frame 6 is sent/transmitted to the gate control receiver to close the gate. Thereafter, there may not yet be a subsequent actuation of the actuator. However, it is possible for a hacker to copy the encrypted frame 4 and re-transmit the copied encrypted frame 4 to the gate control receiver to keep the gate closed. Thus, the hacker may cause problems to the gate by sending the unintended command by copying and resending a copied signal. Such a situation is undesirable. The inventors recognise that even though the signals are encrypted, there is still a possibility of malicious action.

Therefore, in view of the above, there exists a need for a method of recording a frame counter in a memory component of an energy limited/harvesting device and an energy limited/harvesting device to address at least one of the above problems.

### SUMMARY

In accordance with an aspect of the present disclosure, there is provided a method of recording a frame counter in a memory component of an energy limited device, the method comprising, accessing the memory component; wherein for a first recordal, allocating a memory space of the memory component based on a value of a predetermined maximum frame counter number for the energy limited device, with each bit of the allocated memory space being populated with an empty space indicia; and wherein for the first recordal and each subsequent recordal, accessing a first bit position with the empty space indicia based on a predetermined writing instruction and converting the empty space indicia of the first bit position to a frame counter indicia wherein the first bit position with the frame counter indicia indicates a current frame counter number.

The predetermined maximum frame counter number may be based on a number of transmissions anticipated for the energy limited device.

The current frame counter number may be an information that is included in a current signal being transmitted from the energy limited device to a receiver.

The accessing a first bit position with the empty space indicia for each subsequent recordal may comprise, forming a search window over a portion of the allocated memory space; determining, at a predetermined search position within the search window, whether a bit position is populated with the frame counter indicia; and based on whether the bit position at the predetermined position within the search window is populated with the frame counter indicia, moving the search position in one or more directions to locate the first bit position with the empty space indicia, the one or more directions being based on the predetermined writing instruction.

In accordance with another aspect of the present disclosure, there is provided an energy limited device, the device comprising, a transmission component for transmitting one or more signals; a power generator for generating power to operate the transmission component; a processing module; a computer readable medium coupled to the processing module, the computer-readable medium storing instructions, executable by the processing module to perform a method of recording a frame counter in a memory component of an energy limited device, the method comprising, accessing the memory component; wherein for a first recordal, allocating a memory space of the memory component based on a value of a predetermined maximum frame counter number for the energy limited device, with each bit of the allocated memory space being populated with an empty space indicia; and wherein for the first recordal and each subsequent recordal, accessing a first bit position with the empty space indicia based on a predetermined writing instruction and converting the empty space indicia of the first bit position to a frame counter indicia wherein the first bit position with the frame counter indicia indicates a current frame counter number.

The predetermined maximum frame counter number may be based on a number of transmissions of the one or more signals anticipated for the energy limited device.

The current frame counter number may be an information that is included in a current signal being transmitted from the energy limited device to a receiver.

The accessing a first bit position with the empty space indicia for each subsequent recordal may comprise, forming a search window over a portion of the allocated memory space; determining, at a predetermined search position within the search window, whether a bit position is populated with the frame counter indicia; and based on whether the bit position at the predetermined position within the search window is populated with the frame counter indicia, moving the search position in one or more directions to locate the first bit position with the empty space indicia, the one or more directions being based on the predetermined writing instruction.

### BRIEF DESCRIPTION OF THE DRAWINGS

Exemplary embodiments of the present disclosure will be better understood and readily apparent to one of ordinary skill in the art from the following written description, by way of example only, and in conjunction with the drawings, in which:

FIG. 1 is a schematic block diagram for illustrating an energy limited/harvesting device for communicating with a receiver in an exemplary embodiment.

FIG. 2 is a schematic drawing illustrating frame counter checking in an exemplary embodiment.

FIG. 3 illustrates data storage in traditional flash memory.

FIG. 4A is a schematic illustration of a memory storage space of a memory component of an energy limited device in an exemplary embodiment.

FIG. 4B is a schematic flowchart for illustrating a method of recording a frame counter in a memory component of an energy limited device in the exemplary embodiment.

FIG. 5A is a schematic illustration showing writing of a memory space from a beginning part to an end part in an exemplary embodiment.

FIG. 5B is a schematic illustration showing writing of a memory space from a substantially middle part to a beginning part in an exemplary embodiment.

FIG. 5C is a schematic illustration showing writing of the memory space from the middle part to an end part in the exemplary embodiment.

FIG. 6A is a schematic flowchart for illustrating a method of accessing a first bit position with the empty space indicia for each subsequent recordal of an energy limited device.

FIGS. 6(B)(i) to 6B(iv) are schematic illustrations showing searching for a first bit position with an empty space indicia in an exemplary embodiment with a predetermined writing instruction being from a beginning part of an allocated memory space to an end part of an allocated memory space.

FIGS. 6C(i) to 6C(iii) are schematic illustrations for showing searching for a first bit position with an empty space indicia in an exemplary embodiment with a predetermined writing instruction being from a substantially middle part of an allocated memory space to a beginning part of the allocated memory space and subsequently, from the middle part of the allocated memory space to an end part of the allocated memory space.

FIG. 7 is a schematic flowchart for illustrating a method of recording a frame counter in a memory component of an energy limited device in an exemplary embodiment.

### DETAILED DESCRIPTION

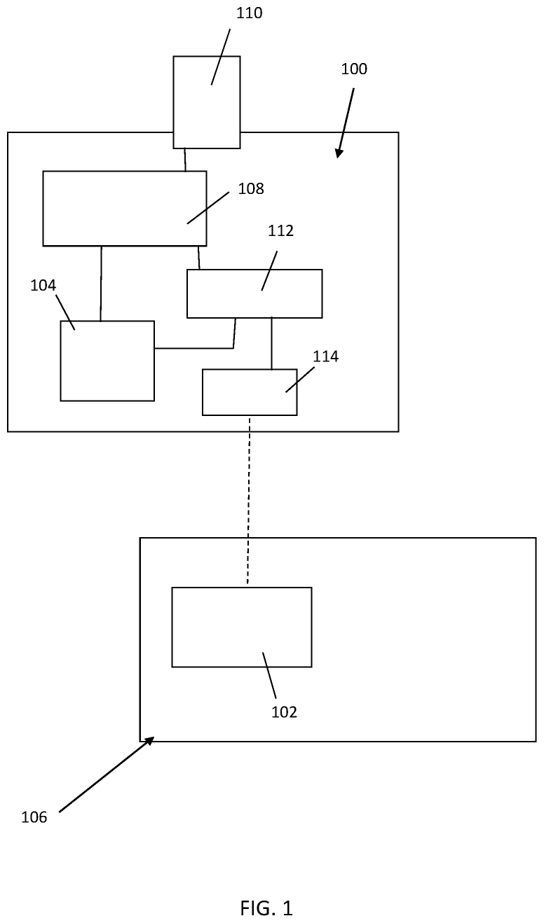

FIG. 1 is a schematic block diagram for illustrating an energy limited/harvesting device for communicating with a receiver in an exemplary embodiment. The energy limited device 100 is capable of communicating with a receiver 102. The communication may be via non-wired or wireless communications. The receiver 102 is coupled to an apparatus/machinery 106 which the energy limited device 100 is controlling/operating. The energy limited device 100 may be a wireless and batteryless transmitter device for communication of signals to the receiver 102.

The energy limited device 100 comprises a microcontroller (or a processing module) 112 and a transceiver/transmission component/mechanism 114. The transceiver/transmission mechanism 114 may include an antenna. In the exemplary embodiment, the microcontroller 112 controls the various components of the energy limited device 100.

In the exemplary embodiment, the energy limited device 100 comprises a frame counter mechanism 104 for recording a frame counter. The frame counter mechanism 104 can retrieve a next frame counter number to be included in a signal to be next transmitted to the receiver 102. That is, the signal to be transmitted to the receiver 102 includes data/information relating to a next frame counter number. In the exemplary embodiment, the frame counter mechanism 104 is a module coupled to the microcontroller 112. In some exemplary embodiments, the microcontroller 112 performs the functions of the frame counter mechanism 104.

The receiver 102 can receive a signal from the frame counter mechanism 104 to operate/control the apparatus/machinery 106. The receiver 102 expects/anticipates a subsequent frame counter number that is received to be larger than a frame counter number that has been previously received.

The energy limited device 100 further comprises a power generator or a power generator module 108 which generates energy/power to activate the energy limited device 100 and an actuation component 110. In an exemplary embodiment, the actuation component 110 is located at a first surface of a housing of the energy limited device 100 and extends into the housing. For example, the first surface may be a top surface of the energy limited device 100. The power generator 108, the frame counter mechanism 104, the microcontroller 112 and the transceiver/transmission mechanism 114 are located within the housing. The power generator 108 may be of any form and type that may generate power to operate the energy limited device 100.

In the exemplary embodiment, a computer readable medium (not shown) is coupled to the microcontroller 112. The computer-readable medium stores instructions which is executable by the microcontroller 112 to perform a method of recording a frame counter in a memory component of the energy limited device 100. The computer readable medium is a non-transitory tangible storage medium with instructions including a predetermined writing instruction. In the exemplary embodiment, the next frame counter number is also stored on the computer readable medium.

As an example, when a mechanical actuator (as the actuation component 110) of the energy limited device 100 is pressed/actuated, the power generator 108 of the energy limited device 100 is activated. A power supply is provided from the power generator 108 to the microcontroller 112 of the energy limited device 100 and the microcontroller 112 boots up or is activated. Typically, the power generator 108 generates a power supply just about sufficient for activating the microcontroller 112 of the energy limited device 100 and for transmitting a signal.

The power supply generated allows the microcontroller 112 to send a communication signal using the transceiver/transmission mechanism 114 of the energy limited device 100 to the receiver 102. That is, the energy limited device 100 transmits the signal including the next frame counter number retrieved from the frame counter mechanism 104 to the receiver 102.

As such, the energy limited device 100 uses energy of the power generator 108 in the energy limited device 100 to start/begin working. Thereafter, there is typically insufficient energy for the energy limited device 100 to stay powered on and the energy limited device 100 typically powers off until the actuation component 110 is activated again. Such a wireless and batteryless transmitter device may typically only generate enough/sufficient power to transmit communication signals to a receiver 102 when the actuation component 110 is activated. The energy limited device 100 then subsequently powers down due to the insufficient/limited power. For example, the energy provided by a power generator in an energy limited device may typically be about 0.5 mWs (milliwatts). Such an energy limited device can typically stay powered on for about 6 ms to 10 ms (e.g. about 2.5 ms for initialization and about 2.5 ms for transmitting multiple radio frames).

The inventors recognise that when there is no frame counting mechanism, a hacker can copy a frame and transmit the signal to a receiver. Without differentiation of one frame from another, the problems identified in the Background section may occur. The inventors recognise that frame freshness checking and a frame counter mechanism can assist in alleviating one or more problems identified in the Background section. The frame counter mechanism 104 allows the receiver 102 to differentiate one frame from another. That is, the exemplary embodiment provides frame freshness checking to ensure that the receiver 102 is receiving a legitimate/allowed signal and that the signal is not compromised/hacked by a hacker.

In the exemplary embodiment, each actuation of the actuation component 110 results in one frame being transmitted by the energy limited device 100. Each frame includes an expected command coupled with a frame counter number. For example, the actuation component 110 may be a button. For example, the expected command may be a command to open or to close a gate. By actuating the actuation component 110, the receiver 102 is instructed to open or to close the gate. A new actuation or frame comprises a sequentially increasing frame counter number being coupled to the frame to be transmitted, the frame counter number increasing as compared to the preceding frame counter number that has been transmitted with a preceding previous frame.

With frame freshness checking, i.e. frame counter checking, the receiver 102 can differentiate between a genuine encrypted frame and a hacked encrypted frame.

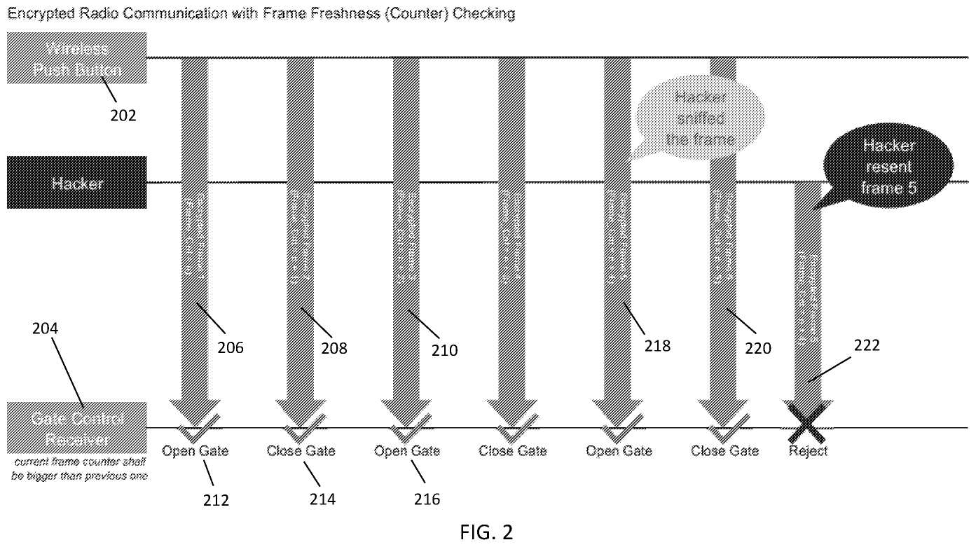

FIG. 2 is a schematic drawing illustrating frame counter checking in an exemplary embodiment. Referring to FIG. 2, there is shown an energy limited device, e,g, a wireless push button 202. The wireless push button 202 is transmitting signals to a gate control receiver 204, each signal being transmitted with an actuation of the wireless push button 202. Each signal comprises a frame counter number. An encrypted frame-1 206 is identified with frame counter number Frame_Cnt=n. A subsequent encrypted frame-2 208 is identified with frame counter number Frame_Cnt=n+1. A subsequent encrypted frame-3 210 is identified with frame counter number Frame_Cnt=n+2 and so on. That is, in the exemplary embodiment, a current frame counter number is bigger than a previous frame counter number. The number of frames is progressively increasing as each subsequent transmission is sent from the energy limited device 202. In the exemplary embodiment, each signal is to open or close a gate sequentially, see e.g. 212, 214, 216.

In the exemplary embodiment, if the encrypted frame-5 218, which is identified with frame counter number Frame_Cnt=n+4 (with command to open the gate) is hacked/compromised and is subsequently sent/transmitted to the gate control receiver 204 after, for example, encrypted frame-6 220 with frame counter number Frame_Cnt=n+5 (see compromised sent signal frame 222), the gate control receiver 204 can usefully detect the discrepancy in the frame counter number, i.e. the receiver 204 is anticipating a larger frame counter number, i.e. Frame_Cnt=n+6 instead of Frame_Cnt=n+4. The receiver 204 can then reject the hacked/compromised encrypted frame 222 since Frame_Cnt=n+4 of hacked/compromised encrypted frame-5 can be determined to be less than Frame_Cnt=n+5 of the preceding encrypted frame-6 220.

As indicated above, for secured data communication, incremental frame counter may usefully be used for data freshness checking. The inventors recognise that a suitable storage method and/or component has to be provided for storing the frame counter numbers, e.g. to determine a next frame counter number for use to transmit a next signal.

The inventors recognise that Flash memory is increasingly used in microcontrollers to store data. Flash memory supports reading, writing and erasing operations. The minimum data managing unit in Flash memory is typically called a “Page” or “Sector”, which is typically made up of a few tens to a few thousands of bytes. Each bit can have either a value of 1 or 0. All bits become 1 after erasing. Each bit can be written from 1 to 0, but it cannot be reversed to 1 afterwards. New data are appended into unwritten areas in the sector. If a sector is fully written, it needs to be erased before new data is saved. The sector erasing time is related to the size of the sector. Typically, the sector erasing time is about 20 ms to 25 ms. The minimum writing or reading size is 32 bits which is made up of 4 bytes.

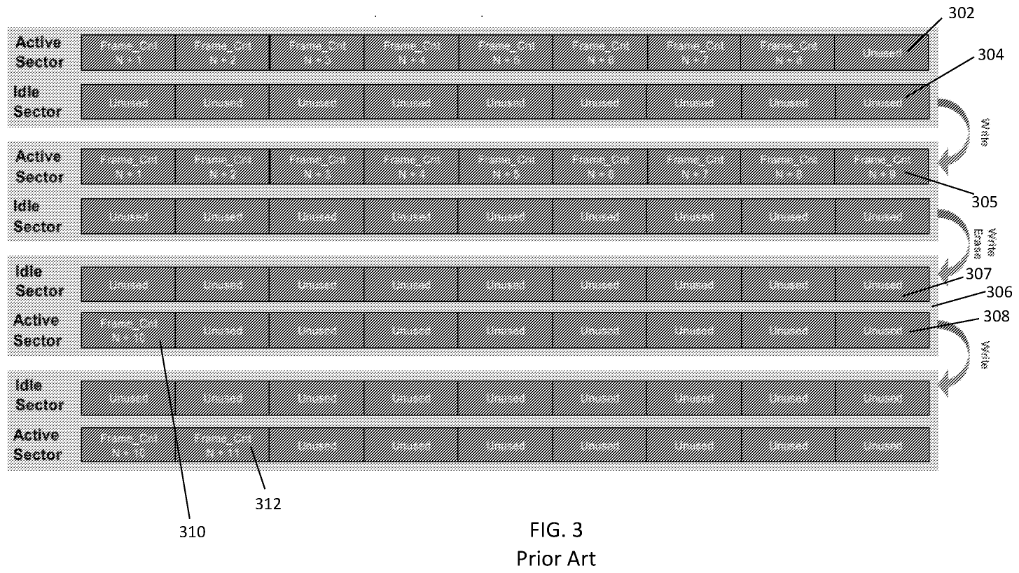

FIG. 3 illustrates data storage in traditional flash memory. It is known that data storage in Flash memory uses a double buffers mechanism. Two sectors 302, 304 are used to save data. One sector 302 is designated an “Active Sector” and the other sector 304 is designated an “Idle sector”. If a new counter number is to be saved, the new data will be written in the first unused space in the active sector 302. See the saving/writing of frame counter number N+9 at numeral 305. If the active sector 302 is fully used, it will be erased fully and becomes an idle sector. The previous idle sector 304 will be activated and will be used to save new data as an active sector. At numeral 306, it is illustrated that if frame counter number N+10 is to be saved/written, the entire full active sector 302 is erased and becomes an idle sector 307, and the idle sector 304 is activated to be an active sector 308 for writing the frame counter number N+10 (see numeral 310). Subsequent saving of data is performed in the active sector 308 (see e.g. numeral 312).

Therefore, with the traditional Flash data storage method, a sector needs to be erased from time to time. The inventors recognise that this is too time consuming and causes too much energy to be used for devices with limited energy. Devices using traditional flash data storage need sufficient time and energy to read or write or erase data.

Due to the issues relating to the time needed for reading/writing/erasing data in traditional Flash storage and the energy needed for such processes, the inventors considered and recognise that traditional Flash memory cannot be used by energy limited devices. For some energy harvesting devices, the size of such devices is typically limited (e.g. portable devices). This kind of device can only comprise a small power generator and hence, generates limited energy. It is recognized that the harvested energy can support the energy limited device to work for about or less than 10 ms whereas for traditional Flash storage, for sector erasing alone, the time for sector erasing is about 20 ms to 25 ms. There is insufficient harvested energy to support an incremental frame counting mechanism with traditional Flash memory or any external memory (external to the microcontroller of an energy limited device). Therefore, the inventors recognise that it is technically difficult to maintain the incremental frame counter mechanism with traditional Flash memory storage for energy limited devices with cyber security features. The inventors also recognise that there is currently no solution with a quick data storage implementation method being used with traditional Flash memory storage methods.

The inventors recognise that internal memory storage of an energy limited device is to be used. Further, limited energy is available for reading and/or writing the internal memory storage, and to transit a frame/signal with a new frame counter number that is incremental with respect to the previous frame counter number transmitted with a previous frame/signal.

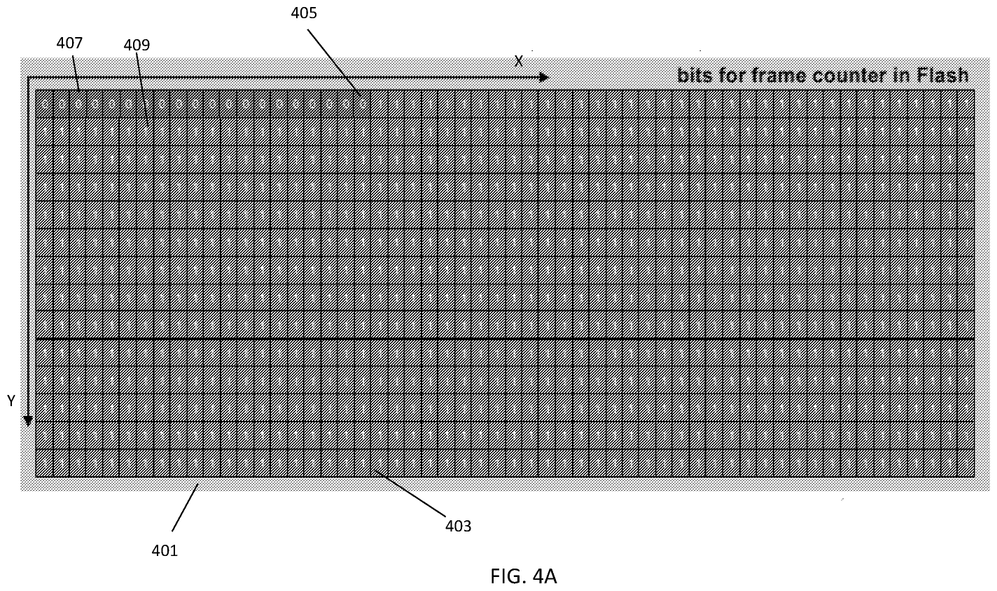

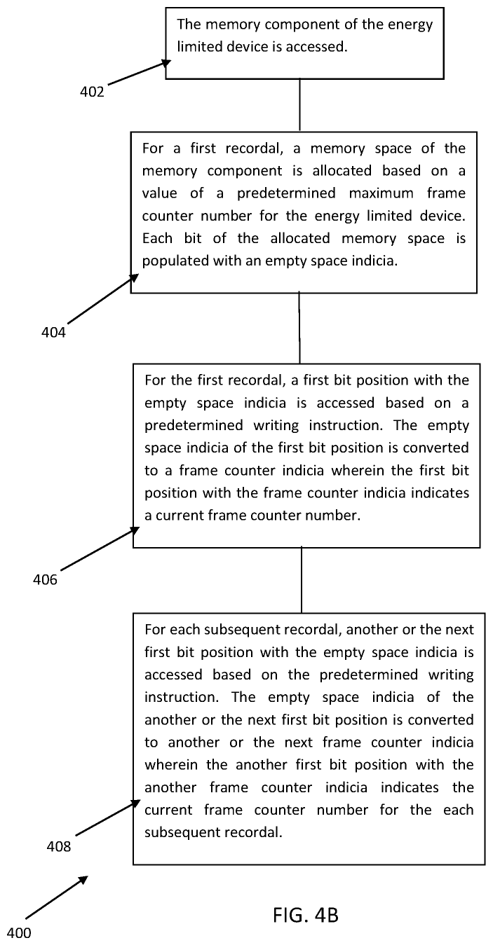

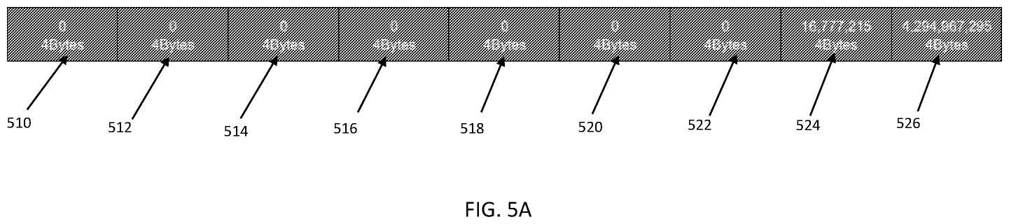

FIG. 4A is a schematic illustration of a memory storage space of a memory component of an energy limited device in an exemplary embodiment. The memory storage space 401 is allocated based on a value of a predetermined maximum frame counter number for the energy limited device. For example, if the predetermined maximum frame counter number is 2 million, the allocated memory storage space 401 is capable of supporting the maximum frame counter number such that a total number of bits e.g. 403, 405 in the allocated memory storage space 401 is bigger than 2 million. Prior to initialization of a first recordal, all bits e.g. 403, 405 are populated with an empty space indicia, for example with a value of 1. For the first recordal and subsequent recordals, the value of the relevant bit is converted to a frame counter indicia, for example with a value of 0. The bits need not be converted from a frame counter indicia to an empty space indicia since the number of bits correspond or are provided bigger or more than the predetermined maximum frame counter number. That is, no erasing is conducted for the allocated memory storage space 401.

For example, based on a predetermined writing instruction, each bit in a first row 407, starting with a first bit in a beginning part of the allocated memory storage space, is converted from an empty space indicia to a frame counter indicia, followed by subsequent bits in the direction X until a last bit in the first row 407. Subsequently, each bit in a second row 409 can be converted from an empty space indicia to a frame counter indicia, starting with a first bit in a beginning part followed by subsequent bits in the direction X until a last bit in the second row 409. That is, when the last bit in each row is converted from an empty space indicia to a frame counter indicia, writing starts from a first bit of the subsequent row in the direction Y.

FIG. 4B is a schematic flowchart 400 for illustrating a method of recording a frame counter in a memory component of an energy limited device in the exemplary embodiment. In the exemplary embodiment, the energy limited device may be a batteryless and wireless transmitter. The energy limited device is substantially similar to the energy limited device of other exemplary embodiments (for example, compare energy limited device 100 of FIG. 1).

At step 402, the memory component of the energy limited device is accessed. For example, a microcontroller (compare microcontroller 112 of FIG. 1) of the device accesses the memory component to cooperate or for use with a frame counting mechanism/module (compare frame counter mechanism 104 of FIG. 1). At step 404, for a first recordal, a memory space of the memory component is allocated based on a value of a predetermined maximum frame counter number for the energy limited device. Each bit of the allocated memory space is populated with an empty space indicia. For example, the allocation may be performed prior to a first usage of the energy limited device. For example, the microcontroller may perform the allocation. At step 406, for the first recordal, a first bit position with the empty space indicia is accessed based on a predetermined writing instruction. The empty space indicia of the first bit position is converted to a frame counter indicia wherein the first bit position with the frame counter indicia indicates a current frame counter number. At step 408, for each subsequent recordal, another or the next first bit position with the empty space indicia is accessed based on the predetermined writing instruction. The empty space indicia of the another or the next first bit position is converted to another or the next frame counter indicia wherein the another first bit position with the another frame counter indicia indicates the current frame counter number for the each subsequent recordal.

In an exemplary embodiment, the predetermined maximum frame counter number for the energy limited device may be stored in a computer readable medium or memory component of the energy limited device. The predetermined writing instruction may also be stored in the computer readable medium which may be executed by a processing module (or microcontroller) of the energy limited device. The computer readable medium is a non-transitory tangible storage medium and may be a non-volatile memory.

In an exemplary embodiment, the predetermined maximum frame counter number is based on a number of transmissions allowed/anticipated for the energy limited device. For example, the predetermined maximum frame counter number may correspond to or be provided to be larger than the maximum number of allowable/anticipated actuations of the energy limited device. As an example, the maximum number of allowable/anticipated actuations may be 2 million. That is, the maximum supported frame counter number for the energy limited device may be corresponding to, or is bigger than, 2 million. As another example, the maximum number of allowable/anticipated actuations may be 3 million. That is, the maximum supported frame counter number for the energy limited device may be corresponding to, or is 3 million. The energy limited device may be designed to have a device lifespan of the maximum number of allowable/anticipated actuations.

In an exemplary embodiment, an empty space indicia may be identified with a value of 1 and a frame counter indicia may be identified with a value of 0 but the exemplary embodiments are not limited as such. For example, in another exemplary embodiment, an empty space indicia may be identified with a value of 0 and a frame counter indicia may be identified with a value of 1.

In an exemplary embodiment, the current frame counter number is an information that is included in a current signal to be transmitted from the energy limited device to a receiver. The receiver is coupled to an apparatus/machinery that the energy limited device is controlling. When the current signal is received by the receiver, the apparatus/machinery may be instructed to perform/conduct a predetermined action, for example opening or closing a gate.

In the exemplary embodiment, to use the energy limited device, when an actuator component on the energy limited device is pressed/actuated, the energy generated in the power generator of the energy limited device is about 0.5 mWs, and the energy limited device is activated to send a signal. When a new frame is to be sent by the energy limited device, a user resets/reactivates the energy limited device by actuating the actuator component.

In the exemplary embodiment, the receiver is able to differentiate one frame from another. The receiver is expecting a sequentially increasing frame counter number. If the current frame counter number is not an increased frame counter number as compared to a previous frame counter number, the receiver determines that the current signal received is not a legitimate/allowed signal and the apparatus/machinery is not instructed to perform/conduct the predetermined action.

In an exemplary embodiment, the frame counter update time is less than 0.1 ms. The update time may include the frame counting mechanism/module accessing/locating a first bit position with an empty space indicia, converting the empty space indicia to a frame counter indicia and sending the bit position as the current fame counter number to the microcontroller for including in the current signal to be transmitted. In one exemplary embodiment, the flash usage for the frame counter mechanism/module is less than 400 kb. Therefore, the memory component of the energy limited device contains more bits than the maximum frame counter number supported by the energy limited device. For example, the memory component may be 500 kb. In such an exemplary embodiment, part of the memory component is assigned for the frame counter storage. For example, if the energy limited device is anticipated to have 2 million transmissions before the device lifespan expires, the exemplary number of bits, e.g. 384 kb or 3,145,728 bits are arranged/allocated as memory space in the memory component for frame counter maintenance. Thus, as an example, more than 3 million bits (or a number more than or based on the value of the predetermined maximum frame counter number (2 million)) may then be allocated/assigned for the frame counter storage. Each bit of the allocated memory space is provided with an empty space indicia or a default/initial value. For example, by default, the empty space indicia or default/initial value of the bits is 1 but the exemplary embodiments are not limited as such. For example, in another exemplary embodiment, by default, the empty space indicia or default/initial value of the bits may be 0.

In an exemplary embodiment with the empty space indicia or initial value of the bits being 1, when the actuator component of the energy limited device is actuated/pushed, the value of a first bit with value 1 is changed to a frame counter indicia which is 0. That is, there is a change from an empty space indicia 1 to a frame counter indicia 0. The processing module counts the number of bits of the allocated memory space with value 0 (i.e. containing the frame counter indicia 0) to obtain the current frame counter number, i.e. the next first bit position with the empty space indicia 1. In the exemplary embodiment, after the value of a bit is changed to a frame counter indica, it is not intended for the bit to be changed to an empty space indicia, i.e. the frame counter number is not repeated and only increases based on a preceding frame counter number.

In an exemplary embodiment, the memory data is divided by 4 bytes. Every set of 4 bytes is termed one item. For a first recordal, all bits in the memory space contain the default empty space indicia, e.g. 1. Therefore, for example, all the items have a default decimal value 4,294,967,295 which is the value for 32 bits of “1”.

In one exemplary embodiment, the predetermined writing instruction is from a beginning part of an allocated memory space to an end part of the allocated memory space.

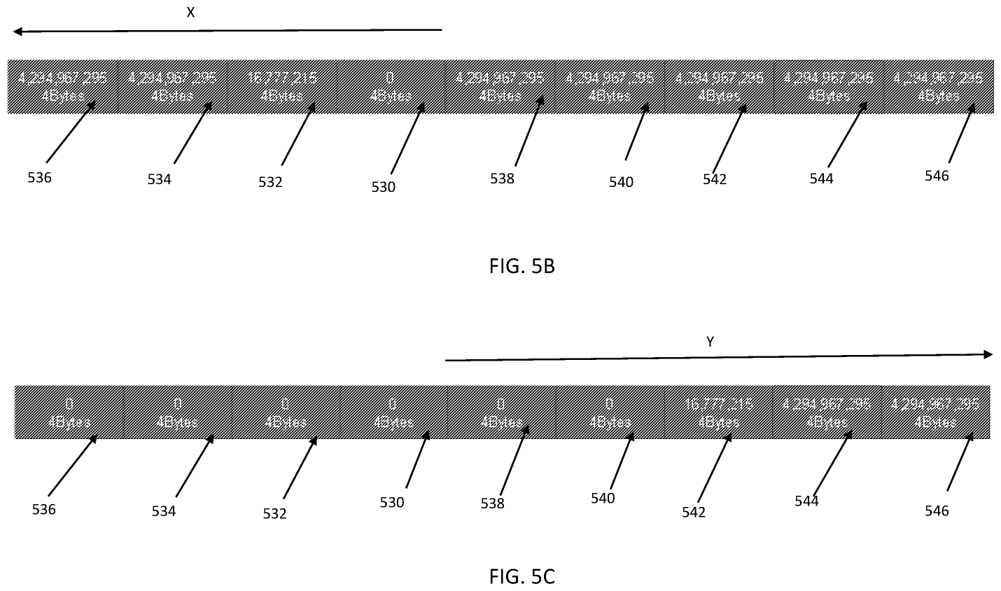

FIG. 5A is a schematic illustration showing writing of a memory space from a beginning part to an end part in an exemplary embodiment. Referring to FIG. 5A, writing starts from a first item 510 which is the beginning part of the allocated memory space. It is appreciated that for a first recordal, before any writing has been performed, each item 510, 512, 514, 516, 518, 520, 522, 524, 526 of the allocated memory space is of a default value of 4,294,967,295. Each bit in each item 510, 512, 514, 516, 518, 520, 522, 524, 526 is populated with an empty space indicia which is 1 in this exemplary embodiment. When writing starts, the first item 510 changes from the default value 4,294,967,295 to another value. For a first recordal, a first bit position of the first item 510 converts from an empty space indicia 1 to a frame counter indicia 0. Subsequently, for a subsequent recordal, an adjacent first bit position with an empty space indicia 1 of the first item 510 is converted to a frame counter indicia 0. When all 32 bits of the first item 510 are changed to 0, the first item is of value 0. Thereafter, writing is made to a first bit position with an empty space indicia 1 of a second item 512 to convert the empty space indicia 1 to frame counter indicia 0. Subsequently, for a subsequent recordal, an adjacent first bit position with an empty space indicia 1 of the second item 512 is converted to a frame counter indicia 0. The process is repeated in a consecutive manner from the beginning part to the end part of the allocated memory space.

In FIG. 5A, a ninth item 526 is the last item at the end part.

The exemplary embodiments are not limited as described above. For example, the predetermined writing instruction may be such that writing is from an end part of the allocated memory space to a beginning part of the allocated memory space, i.e. in the opposite direction to the description provided with reference to FIG. 5A.

In another exemplary embodiment, the predetermined writing instruction is from a substantially middle part of the allocated memory space to both ends of the allocated memory space.

For example, writing is firstly from a first item adjacent to the middle part of the allocated memory space towards a beginning part of the allocated memory space. When all items from the first item to the beginning part are completely written, writing is made from the middle part towards an end part of the allocated memory space.

FIG. 5B is a schematic illustration showing writing of a memory space from a substantially middle part to a beginning part in an exemplary embodiment. FIG. 5C is a schematic illustration showing writing of the memory space from the middle part to an end part in the exemplary embodiment.

Referring to FIGS. 5B and 5C, writing starts from a first item 530 which is adjacent to the middle part of the allocated memory space in the direction X towards the beginning part e.g. towards the item 536 at the beginning part. For a first recordal, before any writing starts, each item 530, 532, 534, 536, 538, 540, 542, 544, 546 of the allocated memory space is of a default value 4,294,967,295 (or 32 bits of “1” leading to the value). Each bit in each item 530, 532, 534, 536, 538, 540, 542, 544, 546 is populated with an empty space indicia which is 1 in the exemplary embodiment. When writing starts, the first item 530 changes from the default value 4,294,967,295 to another value as a first bit of the first item 530 with an empty space indicia 1 is converted to a frame counter indicia 0. For a subsequent recordal, an adjacent first bit position with an empty space indicia 1 of the first item 530 is converted to a frame counter indicia 0. When all 32 bits of the first item 530 are changed to 0, the first item 530 is of value 0 (see FIG. 5B). Subsequently, writing is made to a second item 532. The second item 532 is adjacent the first item 530 in the direction X towards the beginning part of the allocated memory space. For a subsequent recordal, an adjacent first bit position with an empty space indicia 1 of the second item 532 is converted to a frame counter indicia 0. The process is repeated for the second item 532 until all 32 bits of the second item 532 are changed to 0. Writing is made in a consecutive manner in the direction X towards the beginning part.

When the item in the beginning part is of the value 0 (see a fourth item 536 in FIG. 5C), writing is made to items from the middle part and towards the end part of the allocated memory space in the direction Y as shown in FIG. 5C. Writing is made to a fifth item 538. When all 32 bits of the fifth item 538 are changed to 0, the fifth item 538 is of value 0. The process is repeated in a consecutive manner towards the end part, until a ninth item 546 which is the last item at the end part.

The exemplary embodiments are not limited as described above. For example, the predetermined writing instruction may be such that writing is from a substantially middle part of the allocated memory space to the end part of the allocated memory space (compare FIG. 5C e.g. numeral 540 towards the end part of the allocated memory space) followed by from the middle part to the beginning part of the allocated memory space (compare FIG. 5B e.g. numeral 538 towards the beginning part of the allocated memory space).

In the writing instruction described herein, there is no need to erase the bits in any of the sectors or items, e.g. to convert from a frame counter indicia 0 back to an empty space indicia 1.

In an exemplary embodiment, information relating to a first bit position with an empty space indicia 1 is sent in a current frame/signal with the current frame counter number. For example, when an actuation component is actuated, a first bit position with an empty space indicia 1 is converted to a frame counter indicia 0. The bit position with the frame counter indicia indicates a current frame counter number. The current frame counter number is used as information included in a current signal to be transmitted from an energy limited device to a receiver. As an energy limited device is activated for the sending of the frame/signal, a first bit position with an empty space indicia needs to be located/accessed.

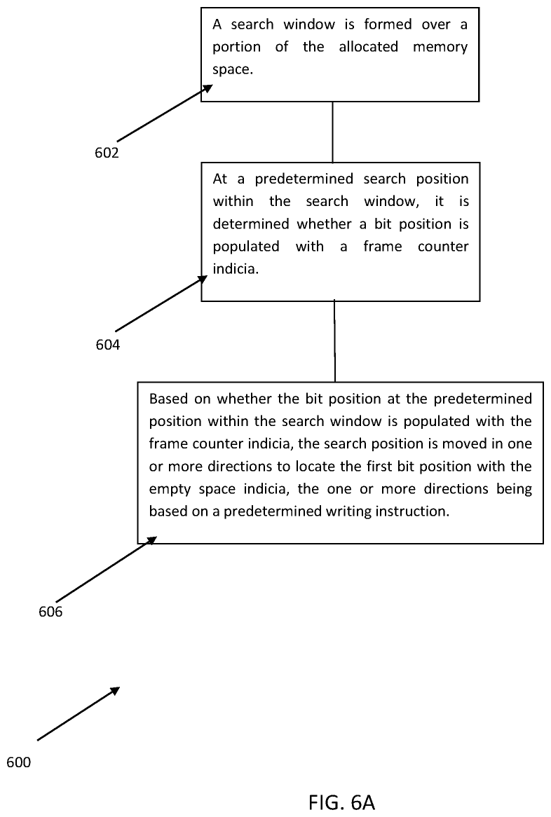

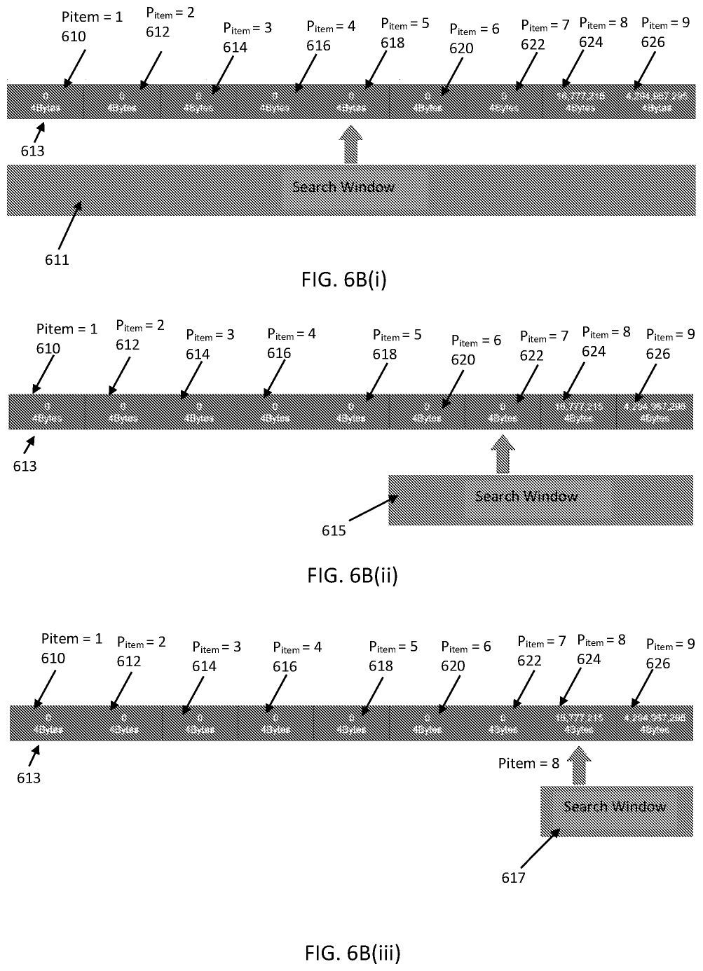

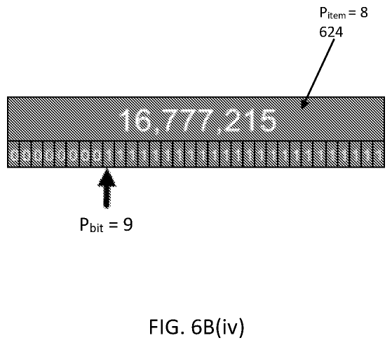

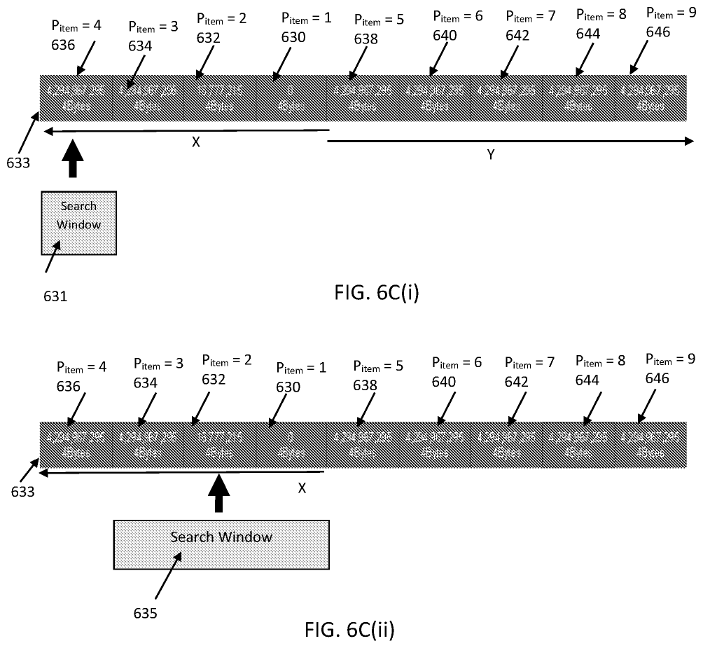

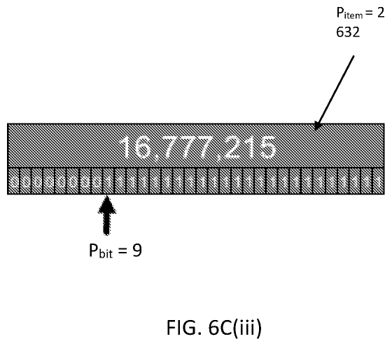

FIG. 6A is a schematic flowchart 600 for illustrating a method of accessing a first bit position with the empty space indicia for each subsequent recordal of an energy limited device. The each subsequent recordal is conducted/performed after a first recordal. At step 602, a search window is formed over a portion of an allocated memory space. At step 604, at a predetermined search position within the search window, it is determined whether a bit position is populated with a frame counter indicia. At step 606, based on whether the bit position at the predetermined position within the search window is populated with the frame counter indicia, the search position is moved in one or more directions to locate the first bit position with the empty space indicia, the one or more directions being based on a predetermined writing instruction.

In the exemplary embodiment, the accessing/searching may be performed by a frame counting mechanism/module and/or a processing module of the energy limited device.

In the exemplary embodiment, when the actuator component/device of the energy limited device is actuated, the processing module finds a position of the first bit position with the empty space indicia, e.g. 1. A search window whose size is the same or smaller than the allocated memory space is created. Based on a predetermined writing instruction, a search is conducted to determine the position of the first bit position with the empty space indicia.

FIGS. 6(B)(i) to 6B(iv) are schematic illustrations showing searching for a first bit position with an empty space indicia in an exemplary embodiment with the predetermined writing instruction being from a beginning part of an allocated memory space to an end part of an allocated memory space. Compare description with reference to FIG. 5A.

In the exemplary embodiment, a first search window 611 is formed over a portion of the allocated memory space 613. The portion may be any size with respect to the allocated memory space. In the exemplary embodiment, the first search window 611 is formed over the entire allocated memory space 613. The allocated memory space 613 includes all items 610, 612, 614, 616, 618, 620, 622, 624, 626. At a predetermined search position within the search window 611, it is determined whether a bit position contains or is populated with a frame counter indicia. In the exemplary embodiment, a central part of the first search window 611 is checked. That is, the value of a fifth item 618 in a middle part of the allocated memory space is checked. If the value of the fifth item 618 is 0, it can be determined that a first bit position with an empty space indicia (for example, 1) is in one of the items located adjacent to the middle part towards the end part of the allocated memory space, i.e. 620, 622, 624, 626, the determination being based on the predetermined writing instruction. That is, it is determined that the fifth item 618 has been completely converted to all bits containing a frame counter indicia. On the other hand, if the value of the fifth item 618 is the default value (for example, 4,294,967,295), it can be determined that the first bit position with the empty space indicia (for example, 1) is located in an item adjacent to the middle part towards the beginning part of the allocated memory space, i.e. items 610, 612, 614, 616. That is, it is determined that all bits of the fifth item 618 contain an empty space indicia. If the value of the fifth item 618 is any value between the default value (for example, 4,294,967,295) and 0, it can be determined that the first bit position with an empty space indicia (for example, 1) is in the fifth item 618.

In the exemplary embodiment, if at the predetermined position within the search window 611, it is determined that the item at the predetermined position is not containing a first bit position populated with an empty space indicia, i.e. if the central part of the first search window 611 is determined such that the item 618 does not contain a value between the default value (for example, 4,294,967,295) and 0, the search position is moved in one or more directions, the one or more directions being based on the predetermined writing instruction. The search process is repeated until an item with a value between the default value (for example, 4,294,967,295) and 0 is found.

Referring to FIG. 6B(ii), if the value of the fifth item 618 at the search position, e.g. the middle part, is 0, the search position is moved towards the end part of the allocated memory space 613, based on the predetermined writing instruction of from the beginning part of the allocated memory space 613 to the end part of the allocated memory space 613. It may be viewed that a second search window 615 is formed which covers all items starting from the adjacent sixth item 620 (which follows the fifth item 618) towards the end part of the allocated memory space (i.e. 620, 622, 624, 626). That is, the second search window 615 is reduced by half as compared to the first search window 611. The search position is moved such that it is substantially the central part of the second search window 615. The central part of the second search window 615 is checked. For example, in the second search window 615, there are four items 620, 622, 624, 626. In the exemplary embodiment, the search position is moved such that the value of a seventh item 622 is checked. If the value of the seventh item 622 is 0, it is determined that a first bit position with an empty space indicia (for example, 1) is in one of the items located from the adjacent eighth item 624 (which follows the seventh item 622) towards the end part of the allocated memory space.

Referring to FIG. 6B(iii), once it is determined that the value of the seventh item 622 is 0, the search position is moved based on the predetermined writing instruction. It may be viewed that a third search window 617 is formed which covers all items starting from the adjacent eighth item 624 (which follows the seventh item 622) towards the end part of the allocated memory space 613 (i.e. 624, 626). That is, the third search window 617 is reduced by half as compared to the second search window 615. The third search window 617 contains only the eighth item 624 and a ninth item 626. In the exemplary embodiment, the search position is moved such that the value of the eighth item 624 is checked. The search position is moved to check the eighth item 624. If the value of the eighth item 624 is 0, it can be determined that a first bit position with an empty space indicia (for example, 1) is in the adjacent ninth item 626 (which follows the eighth item 624). In the exemplary embodiment, it is determined that the value of the eighth item 624 is any value between the default value (for example, 4,294,967,295) and 0. Thus, it is determined that the first bit position with the empty space indicia (for example, 1) is in the eighth item 624.

$$For this example , {P}_{i t e m} = 8 .$$

After an item with the value between the default value (for example, 4,294,967,295) and 0 is located, i.e. the eighth item 624 in FIG. 6B(iii), the eighth item 624 is further checked to determine a first bit position with the empty space indicia (for example, 1).

FIG. 6B(iv) illustrates the 32 bits positions in the eighth item 624. As shown, some of the bits positions are populated with an empty space indicia (for example, 1) and the rest of the bits positions are converted to a frame counter indicia (for example, 0).

The first bit position with the empty space indicia in the eighth item 624, i.e. P_{bit}, is determined to be the ninth bit. That is, P_{bit}=9.

The frame counter number is thus calculated with the following formula:

$$Frame\_Cnt = 32 \times ( {P}_{i t e m} - 1 ) + {P}_{bit}$$

Hence, for the example shown in FIG. 6B(iv):

$$Frame\_Cnt = 32 \times ( 8 - 1 ) + 9 = 233$$

In other words, the seven items before Pᵢₜₑₘ with 32 bits each and all populated with the frame counter indicia are accounted for in the calculation.

The value of Frame_Cnt (or the frame counter number) is then included in a signal currently sent from a transmission component of the energy limited device to a receiver. In the exemplary embodiment, the value of Frame_Cnt is always sequentially increasing. Therefore, the receiver coupled to an apparatus/machinery which is receiving a current signal from the energy limited device is anticipating an increasing Frame_Cnt as compared to a value of a Frame_Cnt in a previous signal received. The receiver is able to differentiate one frame from another. Should the current signal contain a Frame_Cnt with a value lower than the value of the Frame_Cnt in the previous signal, the receiver can determine that the signal is not legitimate and the apparatus/machinery does not carry out the instructed action. That is, frame freshness checking is provided to ensure that the receiver is receiving a legitimate/allowed signal and that the signal is not compromised/hacked by a hacker.

FIGS. 6C(i) to 6C(iii) are schematic illustrations for showing searching for a first bit position with an empty space indicia in an exemplary embodiment with the predetermined writing instruction being from a substantially middle part of an allocated memory space to a beginning part of the allocated memory space and subsequently, from the middle part of the allocated memory space to an end part of the allocated memory space.

In the exemplary embodiment, the allocated memory space includes all items 630, 632, 634, 636, 638, 640, 642, 644, 646. A first item 630 adjacent to a fifth item 638 is first written, in the direction of X towards the beginning part until the beginning part 636, and subsequently from the fifth item 638 of the allocated memory space 633 towards an end part of the allocated memory space 633 in the direction Y. Compare description with reference to FIGS. 5B and 5C. In the exemplary embodiment, a first search window 631 is formed over a portion of the allocated memory space 633. In the exemplary embodiment, the first search window 631 is formed over a fourth item 636 at the beginning part of the allocated memory space 633. At a predetermined search position within the search window 631, it is determined whether a bit position contains or is populated with a frame counter indicia. That is, the value of the fourth item 636 in the beginning part of the allocated memory space 633 is checked. If the value of the fourth item 636 is the default value (for example, 4,294,967,295), it can be determined that a first bit position with an empty space indicia (for example, 1) is in one of the items located from the first item 630 adjacent the middle part in the direction X towards the beginning part of the allocated memory space but before the checked fourth item 636, the determination being based on the predetermined writing instruction. That is, it is determined that all bits of the fourth item 636 contain an empty space indicia. If the value of the fourth item 636 is 0, it can be determined that a first bit position with an empty space indicia (for example, 1) is in one of the items located from the middle part in the direction Y towards the end part of the allocated memory space. That is, items 630, 632, 634, 636 (written before the fifth item 638) are determined to have been converted to containing the frame counter indicia leading to the fifth item 638 onwards being utilized (i.e. based on the predetermined writing instruction). If the value of the fourth item 636 is any value between the default value (for example, 4,294,967,295) and 0, it can be determined that the first bit position with the empty space indicia (for example, 1) is in the fourth item 636.

In the exemplary embodiment, it is determined that the value of the fourth item 636 is the default value (for example, 4,294,967,295). Referring to FIG. 6C(ii), the search position is moved in one or more directions, the one or more directions being based on the predetermined writing instruction. In the exemplary embodiment, the search position is moved to cover the first item 630 adjacent the middle part in the direction X towards the beginning part of the allocated memory space but before the checked fourth item 636 based on the predetermined writing instruction. It may be viewed that a second search window 635 is formed which covers all items starting from the first item 630 in the direction X towards the beginning part of the allocated memory space and before the checked fourth item 636 (i.e. first to third items 630, 632, 634). The search position is moved such that it is substantially the central part of the second search window 635. The central part of the second search window 635 is checked. For example, in the second search window 635, there are three items 630, 632, 634. In the exemplary embodiment, the search position is moved such that the value of a second item 632 is checked. If the value of the second item 632 is the default value (for example, 4,294,967,295), it can be determined that a first bit position with an empty space indicia (for example, 1) is in one of the items located amongst the items starting from the first item 630 adjacent the middle part and the remaining items towards the beginning part of the allocated memory space 633 in the direction X but before the second item 632 (i.e. 630) that is being checked.

In the exemplary embodiment, it is determined that the value of the second item 632 is any value between the default value (for example, 4,294,967,295) and 0. Thus, it is determined that the first bit position with the empty space indicia (for example, 1) is in the second item 632.

$$For this example , {P}_{i t e m} = 2 .$$

After the item with the value between the default value (for example, 4,294,967,295) and 0 is located, i.e. the second item 632 in FIG. 6C(ii), the second item 632 is further checked to determine a first bit position with the empty space indicia (for example, 1).

FIG. 6C(iii) illustrates the 32 bits positions in the second item 632. As an example, some of the bits positions are populated with an empty space indicia (for example, 1) and the rest of the bits positions are converted to a frame counter indicia (for example, 0).

The first bit position with the empty space indicia in the second item 632, i.e. P_{bit}, is determined to be the ninth bit. That is, P_{bit}=9.

The frame counter number is calculated with the following formula:

$$Frame\_Cnt = 32 \times ( {P}_{i t e m} - 1 ) + {P}_{bit}$$

Hence, for the example shown in FIG. 6C(iii):

$$Frame\_Cnt = 32 \times ( 2 - 1 ) + 9 = 41$$

In other words, the one item before Pᵢₜₑₘ with 32 bits and all populated with the frame counter indicia are accounted for in the calculation.

The value of Frame_Cnt (or the frame counter number) is then included in a current signal sent from a transmission component of the energy limited device to a receiver. In the exemplary embodiment, the value of Frame_Cnt is always sequentially increasing. Therefore, a receiver coupled to an apparatus/machinery which is receiving a current signal from the energy limited device is anticipating an increasing Frame_Cnt as compared to a value of a Frame_Cnt in a previous signal received. The receiver is able to differentiate one frame from another. Should the current signal contain a Frame_Cnt with a value lower than the value of the Frame_Cnt in the previous signal, the receiver can determine that the signal is not legitimate and the apparatus/machinery is not instructed to carry out the instructed action. That is, frame freshness checking is provided to ensure that the receiver is receiving a legitimate/allowed signal and that the signal is not compromised/hacked by a hacker.

With reference to FIG. 6C(i), in a scenario of the value if the fourth item 636 is 0, based on the predetermined writing instruction, the search position is then moved to cover the fifth to the ninth items.

In the exemplary embodiments, searching for a first bit position with an empty space indicia can be applied with respect to other predetermined writing instructions. The predetermined writing instruction is not limited to the writing instructions described herein.

In the described examples, the search position is movable in one or more directions with respect to the initial/first search position to locate the first bit position with the empty space indicia. The movement of the search position takes into account a predetermined writing instruction and is also based on a narrowing process that can locate the first bit position with the empty space indicia. For example, a subsequent search position may move away or towards the initial/first search position (e.g. the one or more directions) such that the first bit position with the empty space indicia is determined to be between the subsequent search position and the initial/first search position.

In the exemplary embodiments, when the energy limited device starts up or power up again at the next instance, the process is repeated to perform a subsequent recordal and to obtain a current/next frame counter number for the transmission of a current signal (or the signal to be next transmitted) from the energy limited device.

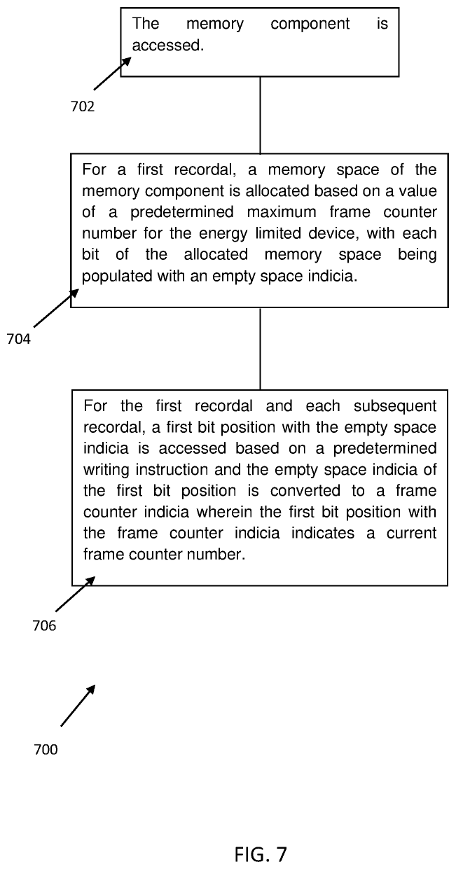

FIG. 7 is a schematic flowchart 700 for illustrating a method of recording a frame counter in a memory component of an energy limited device in an exemplary embodiment. At step 702, the memory component is accessed. At step 704, for a first recordal, a memory space of the memory component is allocated based on a value of a predetermined maximum frame counter number for the energy limited device, with each bit of the allocated memory space being populated with an empty space indicia. At step 706, for the first recordal and each subsequent recordal, a first bit position with the empty space indicia is accessed based on a predetermined writing instruction and the empty space indicia of the first bit position is converted to a frame counter indicia wherein the first bit position with the frame counter indicia indicates a current frame counter number.

In an exemplary embodiment, there can also be provided an energy limited device, the device comprising a transmission component for transmitting one or more signals; a power generator for generating power to operate the transmission component; a processing module; a computer readable medium coupled to the processing module, the computer-readable medium storing instructions, executable by the processing module to perform a method of recording a frame counter in a memory component of an energy limited device, the method comprising accessing the memory component; wherein for a first recordal, allocating a memory space of the memory component based on a value of a predetermined maximum frame counter number for the energy limited device, with each bit of the allocated memory space being populated with an empty space indicia; and wherein for the first recordal and each subsequent recordal, accessing a first bit position with the empty space indicia based on a predetermined writing instruction and converting the empty space indicia of the first bit position to a frame counter indicia wherein the first bit position with the frame counter indicia indicates a current frame counter number.

The predetermined maximum frame counter number is based on a number of transmissions of one or more signals anticipated/allowed for the energy limited device. For example, the number of transmissions may be based on a lifespan of the energy limited device. The current frame counter number is an information that is included in a current signal being transmitted from the energy limited device to a receiver.

In an exemplary embodiment, the computer readable medium also stores instructions for accessing a first bit position with an empty space indica for each subsequent recordal. The method of accessing a first bit position with an empty space indica for a subsequent recordal is as described herein.

For each subsequent recordal, a search window is formed over a portion of the allocated memory space. At a predetermined search position within the search window, it is determined whether a bit position is populated with the frame counter indicia. Based on whether the bit position at the predetermined position within the search window is populated with the frame counter indicia, the search position is moved in one or more directions to locate the first bit position with the empty space indicia, the one or more directions being based on the predetermined writing instruction. For example, the search position may be moved within the search window or as a new search window etc. The search position may be moved in one or more directions, towards or away from a subsequent search position after the predetermined search position, e.g. in a narrowing process.

The energy limited device described herein may be applied with any Non-Volatile Memory (NVM). With the described exemplary embodiments, features enabling cyber security may be applied in energy limited/harvesting devices which traditionally are not able to have such functions due to limitations with the available energy and activation time of such energy limited/harvesting devices. The described exemplary embodiments may be used with ZigBee, Bluetooth and IO Link Wireless based industrial IOT (Internet of Things), industrial control applications, but are not limited as such, i.e. the exemplary embodiments may also be used for other applications.

The inventors recognise that the method and the energy limited device described herein are relatively cheap and easy to implement to existing apparatus/devices. The method allows a shorter time to be used when updating the information relating to the frame counter. For example, due to halving of the search window in each consecutive search cycle (or movement of a search position with respect to a portion of an allocated memory space), there is a shorter time needed in searching for the frame counter number. Latency of the searches is also reduced. For example, traditionally, to search a predetermined maximum frame counter of 2 million bits, one to two million steps may need to be conducted in each search cycle to determine a current frame counter number. For the energy limited device described herein, if the number of transmissions anticipated is 2 million, the maximum number of steps which may be conducted in each search cycle to determine a current frame counter number is fixed at 250 (i.e. square root of (2,000,000/32)).

The inventors recognise that for a typical flash solution, the sector erasing time is about 25 ms. The total running time for a typical device is about 6 ms. The described exemplary embodiments allow the recordal time to be shortened to within 6 ms which can include 2.5 ms for initialization of the device and 2.5 ms for sending multiple radio frames or signals.

The inventors recognise that the exemplary embodiments described herein can usefully allow cyber security features to be provided in an energy limited device.

The terms “coupled” or “connected” as used in this description are intended to cover both directly connected or connected through one or more intermediate means, unless otherwise stated.

The terms “configured to (perform a task/action)”, “configured for (performing a task/action)” and the like as used in this description include being programmable, programmed, connectable, wired or otherwise constructed to have the ability to perform the task/action when arranged or installed as described herein. The terms “configured to (perform a task/action)”, “configured for (performing a task/action)” and the like are intended to cover “when in use, the task/action is performed”, e.g. specifically to and/or specifically configured to and/or specifically arranged to and/or specifically adapted to do or perform a task/action.

The term “and/or”, e.g., “X and/or Y” is understood to mean either “X and Y” or “X or Y” and should be taken to provide explicit support for both meanings or for either meaning.

The terms “associated with”, “related to” and the like used herein when referring to two elements refers to a broad relationship between the two elements. The relationship includes, but is not limited to, a physical, a chemical or a biological relationship. For example, when element A is associated with element B, elements A and B may be directly or indirectly attached to each other or element A may contain element B or vice versa.

The terms “exemplary embodiment”, “example embodiment”, “exemplary implementation”, “exemplarily” and the like used herein are intended to indicate an example of matters described in the present disclosure. Such an example may relate to one or more features defined in the claims and is not necessarily intended to emphasise a best example or any essentialness of any features.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in Bluetooth technology. The computer program when loaded and executed on a suitable reader effectively results in an apparatus that can implement the steps of the described methods.

The exemplary embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the exemplary embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. It is to be appreciated that the individual numerical values within the range also include integers, fractions and decimals. Furthermore, whenever a range has been described, it is also intended that the range covers and teaches values of up to 2 additional decimal places or significant figures (where appropriate) from the shown numerical end points. For example, a description of a range of 1% to 5% is intended to have specifically disclosed the ranges 1.00% to 5.00% and also 1.0% to 5.0% and all their intermediate values (such as 1.01%, 1.02% . . . 4.98%, 4.99%, 5.00% and 1.1%, 1.2% . . . 4.8%, 4.9%, 5.0% etc.,) spanning the ranges. The intention of the above specific disclosure is applicable to any depth/breadth of a range.

In the described exemplary embodiments, the first recordal initialization comprises accessing a first bit position with the empty space indicia based on a predetermined writing instruction. The empty space indicia of the first bit position is then converted to a frame counter indicia wherein the first bit position with the frame counter indicia indicates a current frame counter number. It will be appreciated that the exemplary embodiments are not limited as such. For example, the first recordal initialization may include a step of first erasing an allocated memory space of the memory component to have all bits of the allocated memory space populated with an empty space indicia.

In the described exemplary embodiments, the default value or empty space indicia is “1” and a value of a frame counter indicia is “0”. It will be appreciated that the exemplary embodiments are not limited as such. For example, the default value or empty space indicia may be “0” and the value of the frame counter indicia may be “1”.

In the described exemplary embodiments, it is described that the frame counter number is sequentially increasing with each actuation of an actuator of an energy limited device (and hence, with each signal transmitted by the energy limited device). It will be appreciated that the exemplary embodiments are not limited as such. For example, it may be modified that the frame counter number may be sequentially decreasing with each actuation of an actuator of an energy limited device (and hence, with each signal transmitted by the energy limited device).

In the described exemplary embodiments, the size of one item is 4 bytes and each item contains 32 bits. It will be appreciated that the exemplary embodiments are not limited as such. The size of one item is flexible and hence, each item may contain more than or less than 32 bits.

In the described exemplary embodiments, based on a predetermined writing instruction, a search as described herein is conducted to determine the position of the first bit position with the empty space indicia. The search is based on binary searching algorithm. It will be appreciated that the exemplary embodiments are not limited as such. The search may be conducted based on any quick searching algorithm.

It will be appreciated by a person skilled in the art that other variations and/or modifications may be made to the specific embodiments without departing from the scope of the claimed invention as broadly described. For example, in the description herein, features of different exemplary embodiments may be mixed, combined, interchanged, incorporated, adopted, modified, included etc. or the like across different exemplary embodiments. For example, exemplary embodiments are not necessarily mutually exclusive as some may be combined with one or more embodiments to form new exemplary embodiments. Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments. The present embodiments are, therefore, to be considered in all respects to be illustrative and not restrictive.

1. A method of recording a frame counter in a memory component of an energy limited device, the method comprising,
accessing the memory component;
wherein for a first recordal,
allocating a memory space of the memory component based on a value of a predetermined maximum frame counter number for the energy limited device, with each bit of the allocated memory space being populated with an empty space indicia; and
wherein for the first recordal and each subsequent recordal,
accessing a first bit position with the empty space indicia based on a predetermined writing instruction and converting the empty space indicia of the first bit position to a frame counter indicia wherein the first bit position with the frame counter indicia indicates a current frame counter number.

2. The method as claimed in claim 1, wherein the predetermined maximum frame counter number is based on a number of transmissions anticipated for the energy limited device.

3. The method as claimed in claim 1, wherein the current frame counter number is an information that is included in a current signal being transmitted from the energy limited device to a receiver.

4. The method as claimed in claim 1, wherein the accessing a first bit position with the empty space indicia for each subsequent recordal comprises,
forming a search window over a portion of the allocated memory space;
determining, at a predetermined search position within the search window, whether a bit position is populated with the frame counter indicia; and
based on whether the bit position at the predetermined position within the search window is populated with the frame counter indicia, moving the search position in one or more directions to locate the first bit position with the empty space indicia, the one or more directions being based on the predetermined writing instruction.

5. An energy limited device, the device comprising,
a transmission component for transmitting one or more signals;
a power generator for generating power to operate the transmission component;
a processing module;
a computer readable medium coupled to the processing module, the computer-readable medium storing instructions, executable by the processing module to perform a method of recording a frame counter in a memory component of an energy limited device, the method comprising,
accessing the memory component;
wherein for a first recordal,
allocating a memory space of the memory component based on a value of a predetermined maximum frame counter number for the energy limited device, with each bit of the allocated memory space being populated with an empty space indicia; and
wherein for the first recordal and each subsequent recordal,
accessing a first bit position with the empty space indicia based on a predetermined writing instruction and converting the empty space indicia of the first bit position to a frame counter indicia wherein the first bit position with the frame counter indicia indicates a current frame counter number.

6. The device as claimed in claim 5, wherein the predetermined maximum frame counter number is based on a number of transmissions of the one or more signals anticipated for the energy limited device.

7. The device as claimed in claim 5, wherein the current frame counter number is an information that is included in a current signal being transmitted from the energy limited device to a receiver.

8. The device as claimed in claim 5, wherein the accessing a first bit position with the empty space indicia for each subsequent recordal comprises,
forming a search window over a portion of the allocated memory space;
determining, at a predetermined search position within the search window, whether a bit position is populated with the frame counter indicia; and
based on whether the bit position at the predetermined position within the search window is populated with the frame counter indicia, moving the search position in one or more directions to locate the first bit position with the empty space indicia, the one or more directions being based on the predetermined writing instruction.
